(19) United States
(12) Patent Application Publication
(10) Pub. No.: US 2007/0019645 A1
(43) Pub. Date: Jan. 25, 2007

(54) Method and system for multicasting data in a communication network

(76) Inventor: Deepthy Menon, Bangalore (IN)

Correspondence Address: MOTOROLA, INC., 1303 EAST ALGONQUIN ROAD, IL01/3RD, SCHAUMBURG, IL, 60196, US

(21) Appl. No.: 11/174,911

(22) Filed: Jul. 5, 2005

(51) Int. Cl. H04L 12/56

(52) U.S. Cl. 370/390

(57) ABSTRACT

A method and system for multicasting data in a communication network (100) to a specific group of user equipments (UEs) (120) that includes a source UE (102). The method provides for communicating (302) at least one FlowID to the specific group (120), the communicating including informing the specific group (120) of a broadcast server's IP address and port number to allow the UEs to set up resources in the network (100) for reception of wireless multicast data. The method also includes allowing (303) the source UE (102) to have a floor control for the specific group (120) that are uniquely identified in the network (100), the allowing being provided by a push server (112). Next, the method provides for receiving the data (304) at the broadcast server (114), from the source UE (102), and then multi-casting the data in non-duplicated packets to the specific group (120).

### FIELD OF THE INVENTION

The present invention relates generally to the field of communication networks, and more specifically to multicasting data in communication networks.

### BACKGROUND

With an increase in the need for communication and data transmission, there has been an increased demand for multicasting data, from a single source User Equipment (UE) to a plurality of UEs. Examples of data that can be transmitted include video data, voice data, and data files. Existing services for transmitting data to a plurality of UEs include Push-over-Cellular (PoC) service, Multi Media Broadcast/Multicast Service (MBMS), and Broadcast and Multicast Service (BCMCS). The PoC service enables a user to transmit the data to or interact with another user or group of users. In a group, only one user is allowed to transmit the data at a time, while the other users receive the data. However, the operation of the PoC service is inefficient. Transmission of the data through the PoC service requires duplication of the data packets, at every stage, over the communication network. Therefore, the PoC service has limited usage in operations requiring a high bandwidth.

MBMS is a Third Generation Partnership Project (3GPP) service and BCMCS is a Third Generation Partnership Project 2 (3GPP2) service. MBMS and BCMCS enable point-to-multipoint services in which the data is transmitted from the single-source UE to a plurality of UEs. However, both MBMS and the BCMCS enable unidirectional point-to-multipoint services only for Third Party Broadcast/Multicast Content Providers. Examples of these services include the CNN channel transmitting news to subscriber UEs.

### SUMMARY OF THE INVENTION

According to one aspect of the invention, there is provided a method of multicasting data in a communication network to a specific group of user equipments (UEs) that includes a source UE, the method comprising: communicating at least one FlowID to the UEs in the specific group, the communicating including informing the UEs in the specific group of a broadcast server's IP address and port number to allow the UEs to set up resources in the network, for reception of wireless broadcast or wireless multicasts data; allowing the source UE to have a floor control for the specific group of UEs that are uniquely identified in the communication network, the allowing being provided by a push server in response to the push server receiving a floor control request from the source UE; receiving the data at the broadcast server, the data being transmitted from the source UE ; and multi-casting the data in non-duplicated packets from the broadcast server to the specific group of UEs.

According to another aspect of the invention, there is provided a system for multicasting data in a communication network, the data being provided by a source User Equipment (UE), the system including: a broadcast server, for receiving the data from the source UE through the communication network and transmitting the data in non-duplicated packets to a specific group of UEs; and a push server, for communicating with the broadcast server to communicate Flow ID information there between.

According to yet another aspect of the invention, there is provided a method performed by a UE that forms part a specific group of UEs in a communication network, the specific group of UEs being uniquely identified in the communication network by a FlowID, the method including: receiving from a push server at least one FlowID, a broadcast server's IP address and broadcast server's port number; transmitting a request to the network for a Multicast IP address and associated port number corresponding to the FlowID; receiving the Multicast IP address and associated port number; transmitting a request for registration of the source UE as a valid user of the FlowID; receiving acceptance of the request confirming that the UE is a valid user; and receiving data in a multi-cast transmission at the Multicast IP address and associated port number the data being in non-duplicated packets to all the UEs in the specific group of UEs.

### BRIEF DESCRIPTION OF THE FIGURES

In order that the invention may be readily understood and put into practical effect, reference will now be made to at least one exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a block diagram illustrating the flow of data in a communication network, in accordance with an exemplary embodiment of the present invention;

FIG. 2 is a block diagram illustrating the flow of data in a communication network, in accordance with another exemplary embodiment of the present invention;

FIG. 3 is a flowchart illustrating a method for multicasting data in a communication network, in accordance with an embodiment of the present invention;

FIG. 4 is a flowchart illustrating a method performed by a User Equipment (UE) in a communication network, in accordance with an embodiment of the present invention;

FIG. 5 and FIG. 6 are flow diagrams illustrating call flows during the setup of a multicasting call as per the 3GPP2 standard in a communication network, in accordance with an embodiment of the present invention; and

FIG. 7 is a flow diagram illustrating the transmission of data in an exemplary communication network, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Various embodiments of the present invention provide a method and a system for multicasting data in a communication network. A plurality of User Equipments (UEs) forms a specific group of UEs. A source UE, which is one of the UEs in the specific group of UEs, sends the data to other UEs in the group. The data is routed to a broadcast server in the communication network and the broadcast server multicasts the data, in non-duplicated packets, to the specific group of UEs. The data may also be routed through a push server, depending on whether the specific group of UEs is enabled to receive the multicast data.

Before describing in detail embodiments that are in accordance with the present invention, it should be observed that the embodiments reside primarily in combinations of method steps and system components related to multicasting data in a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article, system or system that comprises a list of elements does not include only those elements but may include other elements not expressly listed or inherent to such process, method, article, system or system. An element proceeded by “comprises . . . a” does not, without more constraints, preclude the existence of additional identical elements in the process, method, article, or system that comprises the element.

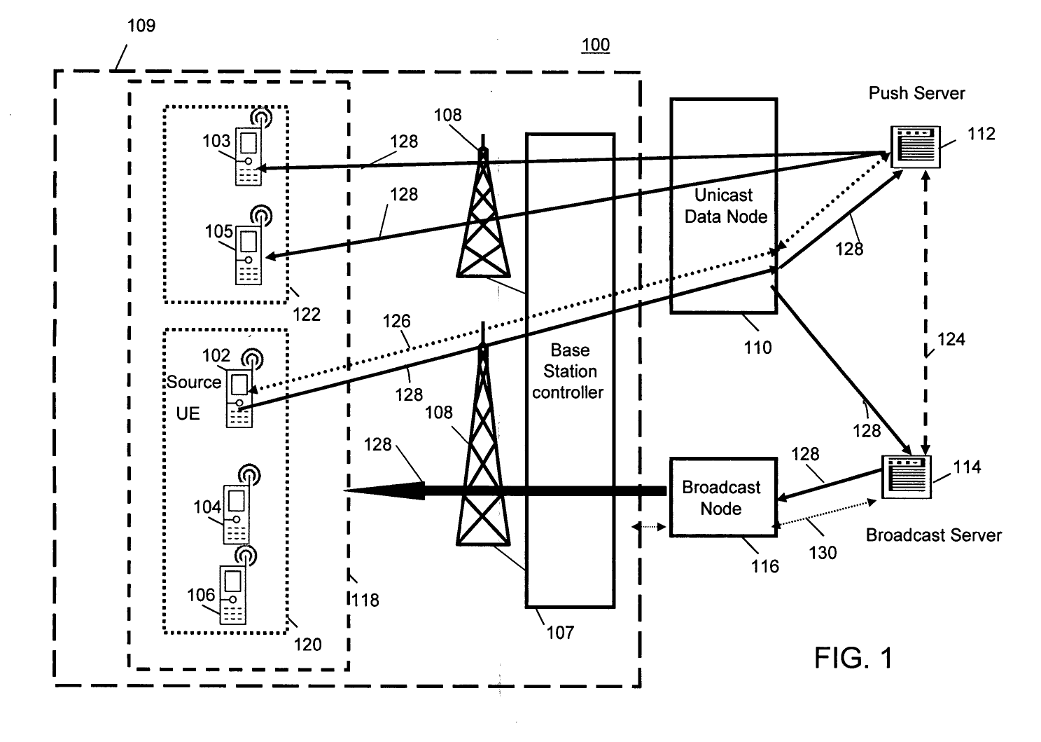

FIG. 1 is a block diagram illustrating the flow of data along data paths 128 in a communication network 100, in accordance with an exemplary embodiment of the present invention. The communication network 100 includes a User Equipment (UE) 102, a UE 103, a UE 104, a UE 105, a UE 106, base stations 108 with associated base station controllers 107, a unicast data node 110, a push server 112, a broadcast server 114, and a broadcast node 116. Examples of UEs include mobile phones, laptops, Personal Digital Assistants (PDAs), and so forth. The communication network 100 may include a plurality of UEs. However, for the purpose of this description, the communication network 100 is shown to include the UEs 102, 103, 104, 105 and 106, which together form a specific group of UEs 118 in which a source UE transmits data to other UEs in the group. For example, the UE 102 is the source UE in the communication network 100, which transmits the data to the UEs 103, 104, 105 and 106. Examples of the data that can be transmitted include, but are not limited to, voice data, video data, and data files.

The unicast data node 110 and the broadcast node 116 are routers for routing the data to and from the wireless access network 109 comprising of a plurality of UEs, a set of base stations 108 and associated base station controllers 107 in the communication network 100. The specific group of UEs 118 includes a multicast subscribed subgroup 120 and a non-multicast subscribed subgroup 122. The multicast subscribed subgroup 120 includes the UEs 102, 104 and 106 that are enabled to receive multicast data in the form of wireless broadcast packets such as, but not limited to Multi Media Broadcast/Multicast Service (MBMS) (for 3GPP) data packets or Broadcast and Multicast Service (BCMCS) (3GPP2) data packets. The non-multicast subscribed subgroup 122 includes the UEs 103 and 105 that are not enabled to receive multicast data in the form of MBMS (for 3GPP) data packets or BCMCS (3GPP2) data packets. A UE may belong to the multicast subscribed subgroup 120 or the non-multicast subscribed subgroup 122 depending on whether the UE supports the wireless broadcast /multicast services, and whether the corresponding base station to which the UE is connected supports the wireless broadcast/multicast services.

In the communication network 100, the source UE 102 is in communication with the push server 112. The push server 112 further communicates with the broadcast server 114 for controlling the transmission of data. The push server 112 can be a Push-over-Cellular (PoC) server, and the broadcast server 114 can be a MBMS content server or a BCMCS content server. The control information exchange between some of the entities, for example, the UEs in group 118 and the push server 112 in the communication network 100 can be in the form of SIP (Session Initiation Protocol) packets containing SDP (Session Description Protocol) attributes over Real Time Control Protocol (RTCP) packets. A data path 124 represents a communication interface established between the push server 112 and the broadcast server 114. The data path 124 can be used for the exchange of security, authentication, and control information, using at least one of the existing, but not limited to, communication interfaces such as the User Datagram Protocol (UDP), the Transmission Control Protocol (TCP), and the Stream Control Transmission Protocol (SCTP) over Internet Protocol (IP). Existing MBMS or BCMCS service uses a FlowID 130 which identifies a unique multicast IP address and port number, which the UEs 120 can join in order to receive broadcast and multicast packets sent by the broadcast/multicast server through the communication network 100. For example, in existing MBMS/BCMCS, the FlowID 130 is exchanged between the wireless network 109, the broadcast/multicast node 116 and broadcast/multicast server 114. In addition, the data path 124 can be used to exchange a FlowID 130, which identifies specific group of UEs 118. It should be noted that there may be more than one such FlowID 130 assigned for a group of UEs, each of these FlowIDs are typically assigned to a specific form of media such as voice, audio, video etc. A data path 126, routed through the base stations 108, represents the flow of RTCP packets, containing SDP attributes, in the communication network 100.

The source UE 102, or for that matter any UE in the group of UEs 118 sends data intended for the other UEs in group 118 to the multicast IP address and port number mapped by FlowID 130 through the wireless communication network 109 and the unicast data node 110. Typically, the data is sent in the form of Real Time Protocol (RTP) packets. Data paths 128, routed through the base stations 108, represent the flow of RTP packets in the communication network 100. The unicast data node 110, routes the data along the data paths 128 to all the receivers that have joined the multicast IP address and port number mapped by the FlowID 130, the receivers which include the broadcast server 114, and optionally the push server 112. The broadcast server 114 further transmits the data to the UEs 102, 104 and 106 via the broadcast node 116 and the wireless communication network 109. The transmission of the data from the broadcast server 114 to the UEs 102, 104 and 106 is carried out as per the existing wireless broadcast/multicast mechanisms, such as, but not limited to MBMS or BCMCS standards.

In an embodiment of the present invention, the push server 114 keeps a record of the UEs in the multicast subscribed subgroup 120 and the non-multicast subscribed subgroup 122. When it is required to send data to a UE in the non-multicast subscribed subgroup 122, the push server 114 joins the multicast IP address group mapped by the FlowID 130 through a standard Multicast Group Management Protocol such as, but not limited to, Internet Group Management Protocol (IGMP). The push server 114 then receives data from the unicast data node 110, and routes the data to the non-multicast subscribed subgroup 122 as per the existing standards. Typically, the data is also transmitted to the source UE 102, since the source UE 102 is a part of the specific group of UEs 118. The source UE 102 has the option of receiving the multicast data. To avoid an echo or inconvenience, the source UE 102 can choose to disregard the multicast data by operating on a mute mode while transmitting the data.

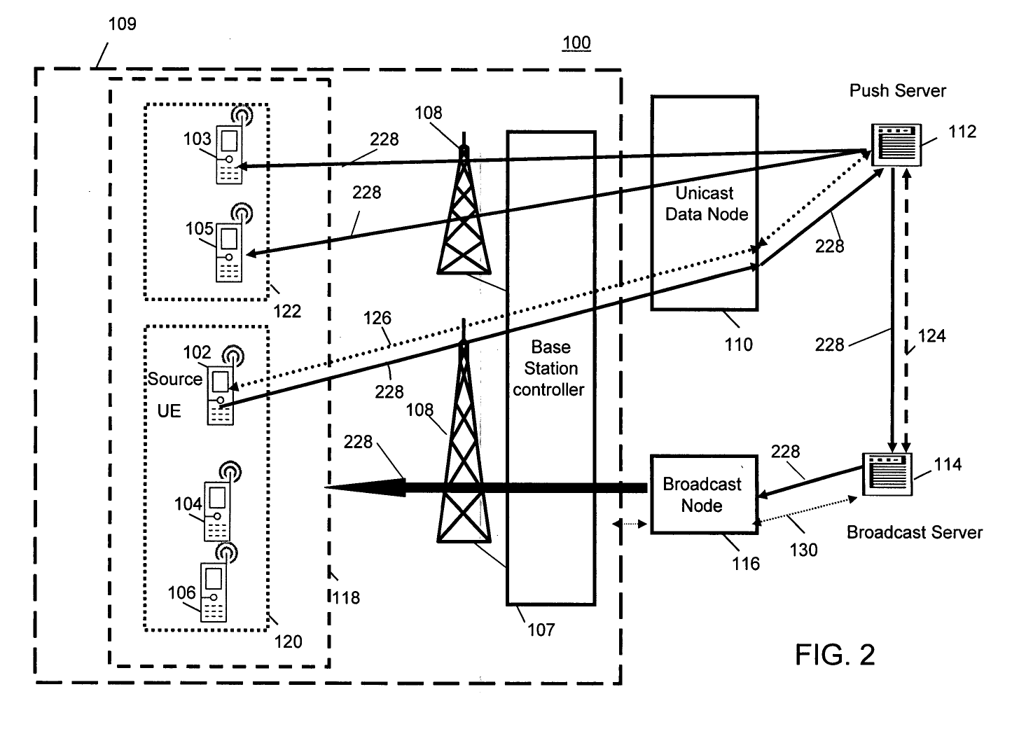

FIG. 2 is a block diagram illustrating the flow of data along data paths 228 in the communication network 100, in accordance with another exemplary embodiment of the present invention. The source UE 102, or for that matter any UE in the group of UEs 118, sends data intended for the other UEs in group 118 to the push server 112 through the wireless communication network 109 and the unicast data node 110. The data is typically sent as RTP packets and the data paths 228, routed through the base stations 108, represents the flow of RTP packets. The unicast data node 110 transmits the data to the push server 112, which in turn transmits the data to the non-multicast subscribed subgroup 122. To transmit data to the multicast subscribed subgroup 120, the push server 112 routes the data to the to the multicast IP address and port number mapped by FlowID 130, which includes broadcast server 114. The broadcast server 114 sends the data in non-duplicated packets to the broadcast node 116, which then transmits the data to the multicast subscribed subgroup. For example, the broadcast node 116 transmits the data to the UEs 102, 104 and 106, which are a part of the multicast subscribed subgroup, through the broadcast node 116 and wireless communication network 109. The source UE 102 may also receive the multicast data, and may disregard the multicast data by operating on a mute mode.

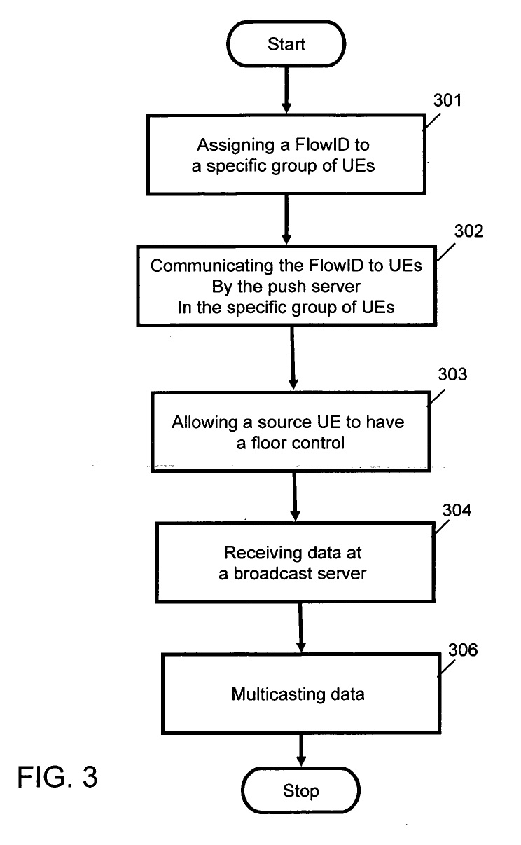

FIG. 3 is a flowchart illustrating a method for multicasting the data in the communication network 100, using either data paths 128 or 228. At step 301, the specific group of UEs 118 is assigned a FlowID 130. The source UE 102 or any other of the UEs in the specific group of UEs 118 sends a group conference initiation request to the push server 112. The group conference initiation request includes an IP address and port number identifying the source UE 102 or another UE in the group of UEs 118. After receiving the group conference initiation request, the push server 112 communicates with the broadcast server 114, to assign the FlowID 130 to the specific group of UEs 118. The FlowID 130 provides a unique identification of the specific group of UEs 118 in the communication network 100. Assigning the FlowID 130 includes mapping it to a unique multicast Internet Protocol (IP) address and port number. Once the FlowID 130 is assigned, broadcast server 114 joins the multicast IP address port number mapped by the FlowID 130.

At a step 302, the assigned FlowID 130, is communicated to the specific group of UEs 118 by the push server 112. Also, the broadcast/multicast server 114, and optionally, the push server 112, join the multicast IP address group mapped to by the FlowID 130. The communicating also includes informing the UEs in the specific group of a broadcast server's IP address and port number to allow the UEs to set up necessary resources in the network; for reception of wireless broadcast or wireless multicast data. These resources are set up provided that the necessary authentication and registration procedures have been setup successfully within the network 100. Once the resources are set up successfully then the UEs in the specific group of UEs 120 also join the multicast group mapped by the FlowID 130.

At a step 303, the source UE 102 (or any other of the UEs in the UEs in the specific group of UEs) is allowed to have a floor control by the push server 112 for the specific group of UEs 118. For instance, the source UE 102 can make a request for the floor control from the push server 112 by sending a floor control request. If the push server 112 allows floor control to the source UE 102, in response to the floor control request, the source UE 102 sends the data as RTP packets either to the multicast IP address and port number mapped by the FlowID 130, through the wireless communication network 109 and the unicast data node 110, or to the push server 112 via the wireless communication network 109 and the unicast data node 110. If the data is sent to the push server 112, the push server 112 shall forward it to any receiver (which includes the broadcast server 114), which is a part of the multicast IP address and port number mapped by the FlowID 130 by the push server 112.

At step 304, the data is received at the broadcast server 114. At step 306, the data is multicast to the multicast subscribed subgroup 120 in the specific group of UEs 118. The broadcast server 114 sends the data in non-duplicated packets to the broadcast node 116, which then transmits the data to the multicast subscribed subgroup. For example, the broadcast server 114 sends the data in non-duplicated packets to the broadcast node 116, which then transmits the data to the UEs 102, 104 and 106 through the wireless communication network 109. It should be noted that if the push server 112 receives the data transmitted by source UE 102 for the other UEs in group 118, the push server 112 forwards the data to the non-multicast subscribed subgroup 122 in the specific group of UEs 118.

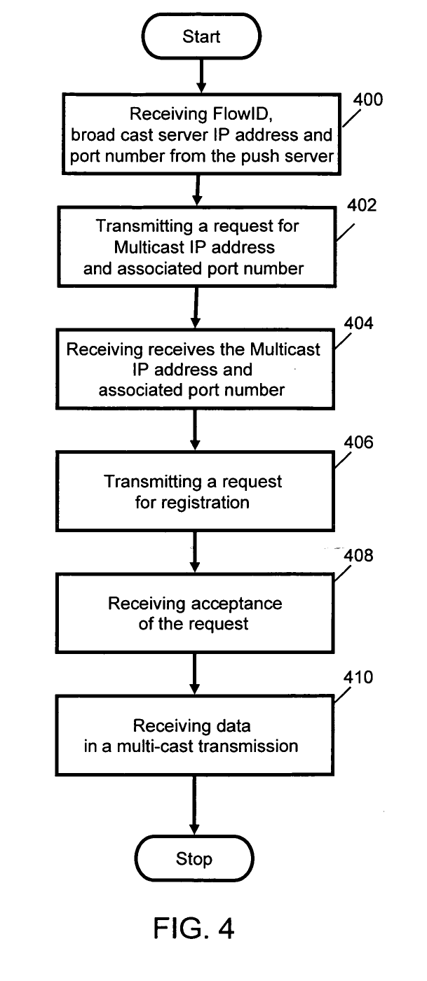

FIG. 4 is a flowchart of a method performed by the source UE 102 or any other UE in group 120 in the communication network 100, using either data paths 128 or 228. At step 400, the source UE 102 receives a FlowID 130, and the IP address, port number of the broadcast/multicast server 114 from the push server while in the process of setting up a group conference call.

At step 402, the method performs transmitting a request the network 100 for a Multicast IP address and associated port number corresponding (mapped) to the FlowID. Next, at step 404, the UE receives the Multicast IP address and associated port number, thereafter at step 406, the source UE effects transmitting a request for registration of the source UE as a valid user of the FlowID. In response to step 406, the network may accept the source UE as a valid user. Hence, if accepted, then at a step 408, the source UE allows for receiving acceptance of the request confirming that the UE is a valid user.

Finally, at a step 410, the source UE can operate to provide for receiving data in a multi-cast transmission at the Multicast IP address and associated port number the data being in non-duplicated packets to all the UEs in the specific group of UEs. The source UE 102 informs the push server that it has joined the multicast IP address and port number mapped by the FlowID by echoing back the FlowID in subsequent control messages to the push server 112. Furthermore, if the data paths 128 are used for routing data then the source UE 102 optionally receives instructions from the push server 112 instructing the source UE 102 to set the intended target destination for any RTP or non control packet to the multicast IP address and port number mapped by the FlowID 130. Alternatively, if the data paths 228 are used for routing data, then the source UE 102 receives instructions from the push server 112 instructing the source UE 102 to set the intended target destination for any RTP or non control packet to the IP address and port number of the push server 112.

It should be noted that after 410, the source UE 102 may send a floor control request to the push server 112. The floor control request is for floor control of the specific group of UEs 118 that are uniquely identified in the communication network 100. Floor control is required to enable the transmission of the data from the source UE 102 with the floor control to the specific group of UEs 118. The source UE 102 receives allowance of the floor control from the push server 112.

The push server 112 allows the source UE 112 to have floor control, in response to the floor control request made by the source UE 102. The source UE 102 starts transmitting the data after receiving the floor control. The source UE 102 transmits the data as RTP packets that eventually reach the broadcast server 114 using either data paths 128 or 228. The broadcast server 114 multicasts the data in non-duplicated packets to all the UEs in the specific group of UEs 118. These non-duplicated packets are routed through communication network 100 and reach the base stations 108. The base stations 108 then transmit the packets to the specific group of UEs 118. Also, the source UE 102 receives the multicast data from the broadcast server 114. The source UE 102 is one of the UEs in the specific group of UEs 118, in accordance with an embodiment of the present invention. The source UE 102 may choose to disregard the multicast data, in order to avoid an echo at its end and the source UE 102 may disregard the multicast data by operating on a mute mode during transmission of the data.

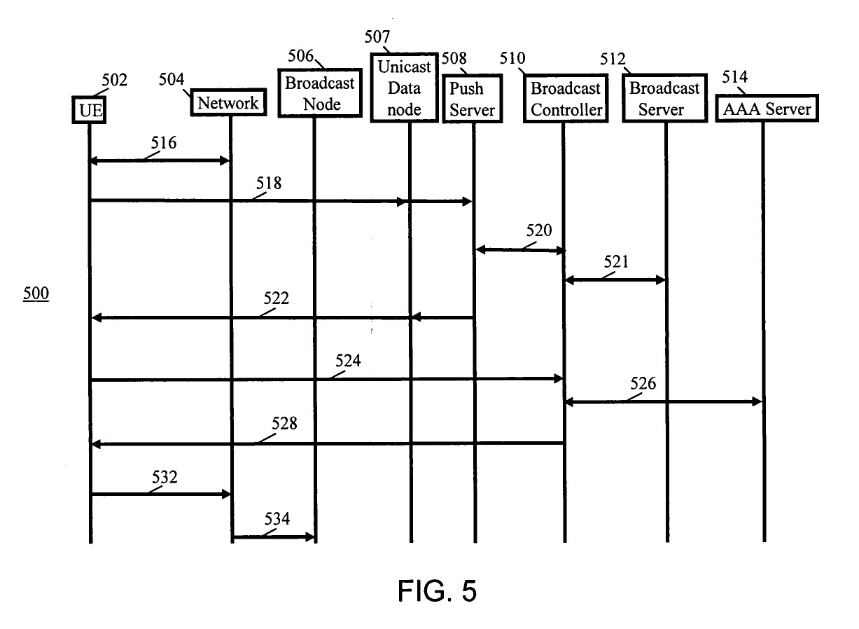

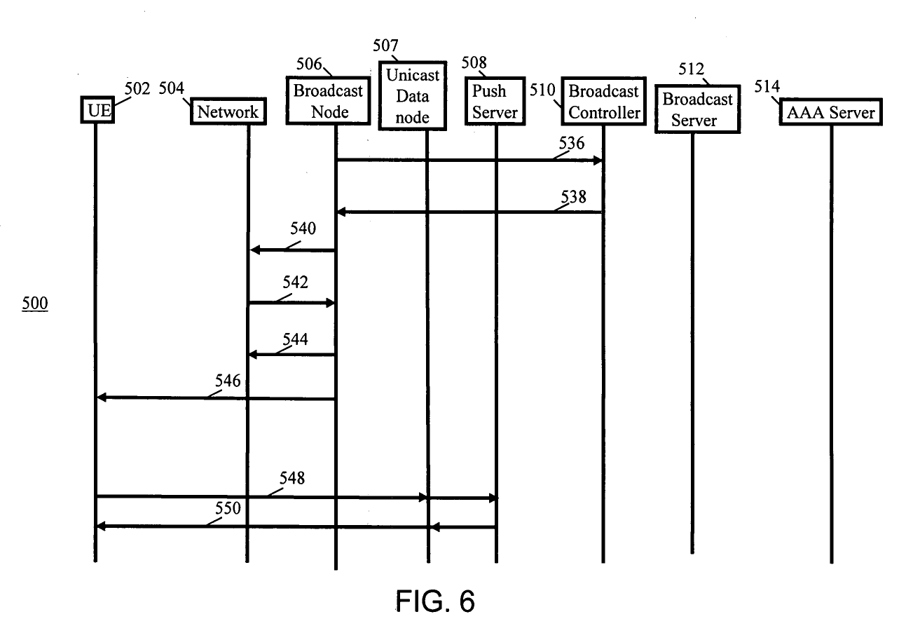

FIG. 5 and FIG. 6 are flow diagrams illustrating call flows during the setup of a multicasting call as per the 3GPP2 standard in a communication network 500, in accordance with an embodiment of the present invention. It should be noted that though these flow diagrams are explained in accordance with the 3GPP2 standard, any other standard that supports multicasting of data can also be used to enable various embodiments of the present invention. The communication network 500 includes a source UE 502, a wireless network 504, a broadcast node 506, a unicast data node 507, a push server 508, a broadcast controller 510, a broadcast server 512, and an Authentication, Authorization and Accountin(AAA) server 514. The broadcast controller 510 is responsible for managing and providing the BCMCS session information to the broadcast node 506 and broadcast server 512.

The broadcast controller 510 and the broadcast server 512 can be combined into a single entity that performs the functions of both the broadcast controller 510 and the broadcast server 512. The source UE 102 transmits the data to the specific group of UEs 118. The data is sent to the unicast data node 507 through the wireless network 504. The broadcast node 506 and the unicast data node 507 are routers for routing the data in the communication network 500. The unicast data node 507 routes the data further to the push server 508. Examples of the push server 112 include a Push-over-Cellular (PoC) server. The push server 508 routes the data to the broadcast server 512 through the broadcast controller 510. Examples of the broadcast server 512 include MBMS content servers and BCMCS content servers. The AAA server 514 is an authentication server used in network access control. It stores the usernames and passwords to identify the UEs. The AAA server 514 is also referred to as a Radius server.

A signal 516 represents call origination, wherein the source UE 502 communicates with the network 504. A signal 518 sends a group conference initiation request in the form of a SIP_INVITE message. In an embodiment of the present invention, the SIP messages (for example, SIP_INVITE, SIP_UPDATE and the like) described herein include SDP attributes. The source UE 502 sends the group conference initiation request to the push server 508, The group conference initiation request includes an IP address and port number identifying the source UE 502. After receiving the group conference initiation request, the push server 508 communicates with the broadcast controller 510, to assign a FlowID to the specific group of UEs 118 to which the source UE 502 belongs, through a signal 520. The FlowID provides a unique identification of the specific group of UEs 118 in the communication network 500. Assigning the FlowID includes mapping it to a unique multicast Internet Protocol (IP) address and port number.

The FlowID can be assigned statically or dynamically. Static assigning of the FlowID includes mapping a unique multicast Internet Protocol (IP) address and port number permanently to the specific group of UEs 118. Dynamic assigning of the FlowID includes instructing the broadcast controller 510 to release the dynamic FlowID when a last UE leaves the specific group of UEs 118. Also, the broadcast server 512 and optionally the push server 508 are removed from the multicast IP address and port number corresponding to the flow ID. The dynamic assigning of the FlowID enables the broadcast controller 510 to assign the released FlowID to another specific group of UEs 118. Typically, once the FlowID 130 is assigned the broadcast server 512 joins as a member of the multicast IP address and port number mapped by the FlowID 130 by a signal 521, Now the broadcast server 512 is in a position to receive any data that is sent to the multicast IP address and port number. The assigned FlowIDs are communicated to the source UE 502 through a signal 522, along with the IP address and port number of the broadcast controller 510. This communication is in the form of an SIP_OK. The SIP_OK also contains an additional new SDP attribute, which has the IP address and port number of the broadcast controller 510 and the FlowID 130.

Through a signal 524, the source UE 502 sends an information acquisition request to the broadcast controller 510. The information acquisition request relates to a multicast IP address of the FlowID and a port number. The necessary authentication procedures are carried out through a signal 526 between the broadcast controller 510 and the AAA server 514, to authenticate the source UE 502. After authentication procedures, the broadcast controller 510 communicates a multicast IP address and the port number mapped by the FlowID 130 to the source UE 502 through a signal 528, in response to the information acquisition request.

Signals 532 through 546 (with reference to FIG. 5 and FIG. 6) represent control signals involved in registering the source UE 502 as a valid recipient of any packets intended for the multicast IP address and port number mapped by the FlowID 130. The source UE 502 sends a registration request to the network 504 through a signal 532. The registration request includes the FlowID 130 received by the source UE 502. The network 504 forwards the registration request to the broadcast node 506 through a signal 534. The broadcast node 506 forwards the registration request to the broadcast controller 510 through a signal 536. The broadcast controller 510 sends an acceptance to the broadcast node 506, in response to the registration request, through a signal 538. Through signals 540 through 544, the wireless network 504 communicates with the broadcast node 506 for acceptance of the registration request. Through the signal 540, the broadcast node 506 communicates a service response to the network 504. Through the signal 542, the network 504 communicates a registration request to the broadcast node 506. Through the signal 544, the broadcast node 506 communicates a registration response to the network 504. The broadcast node 506 communicates the registration acceptance to the source UE 502, thereby accepting the source UE 502 a part of the specific group of UEs 118, through a signal 546.

Through a signal 548, the source UE 502 sends a SIP_UPDATE message to the push server 508. The additional SDP attributes in the SIP_UPDATE message echoes back the FlowID 130 for the multicast subscribed group of UEs. Through a signal 550, the push server 508 acknowledges the SIP_UPDATE message by sending a SIP_OK message, with the additional SDP attribute containing the FlowID 130 to the multicast subscribed group of UEs. In an embodiment of the present invention, the push server 508 has the option of joining the multicast subscribed subgroup. The push server 508 joins the multicast subscribed subgroup 120 when the specific group of UEs 118 includes at least one member of UE in the non-multicast subscribed subgroup 122.

After joining the multicast subscribed group, the push server 508 is capable of receiving data intended to the multicast group of UEs 120, and also capable of forwarding the data to the non-multicast subscribed subgroup 122. In an embodiment of the present invention, when a new UE joins the specific group of UEs 118, the push server 112 communicates the FlowID, IP address, the IP address and port number of the broadcast controller 510 and other relevant information to the new UE. This enables the new UE to setup the multicast capability if it supports it. This enables the new UE to receive multicast data in non-duplicated packets.

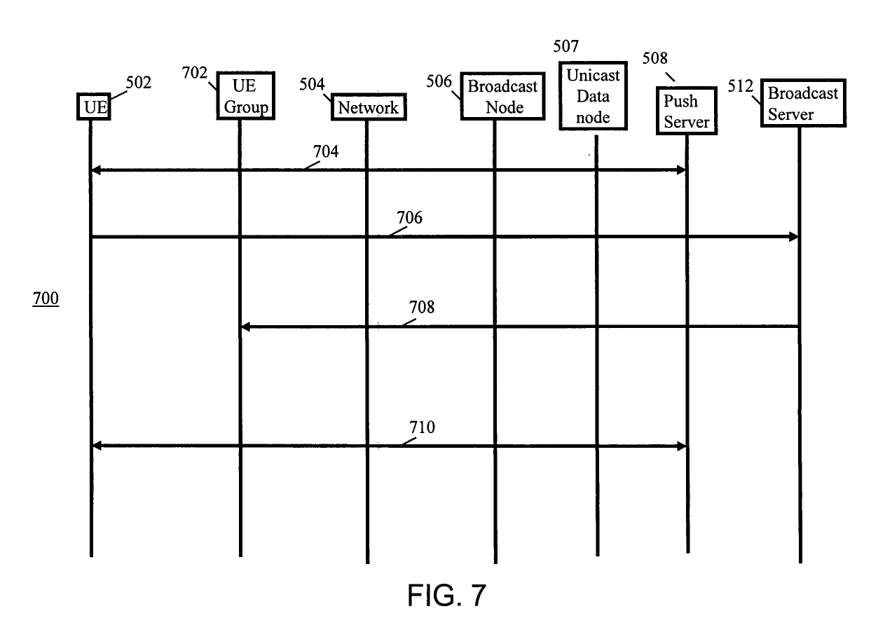

FIG. 7 is a flow diagram illustrating the transmission of the data in an exemplary communication network 700, in accordance with an embodiment of the present invention. The communication network 700 includes a specific group of UEs 702, in addition to the entities referred to in FIG. 5 and FIG. 6. The source UE 502 transmits the data to the specific group of UEs 702. The source UE 502 makes a request for floor control to the push server 508, for the purpose of transmitting the data, through a signal 704. Through a signal 706, after receiving permission for transmission of the data, the UE 502 sends the data to the multicast IP address and port number mapped by the FlowID 130, either directly (as in FIG. 1 or indirectly as in FIG. 2). Since the broadcast server 512 has also joined to the corresponding multicast IP address and port number mapped by FlowID, the broadcast server 512 receives the data. Through a signal 708, the broadcast server 512 multicasts the data to the specific group of UEs 702. During this process, the source UE 502 is operating on a mute mode, so it does not receive the data, which may cause an echo in the source UE 502. The source UE 502 makes a request for release of floor control to the push server 508 through a signal 710, after sending the data. Once the transmission of the data is complete, the source UE 502 emerges from the mute mode.

Advantageously, the present invention provides a method and system for multicasting data as described above, typically the system comprises the broadcast server 112 and multicast server 114 in which data is provided by a source User Equipment (UE) and the broadcast server 112 provides for receiving the data from the source UE through the communication network 100 and transmitting the data in non-duplicated packets to a specific group of UEs. Also, the push server 112 provides for communicating with the broadcast server 114 to communicate the Flow ID information.

Various embodiments of the present invention, as described above, provide a method and system for multicasting data from a single UE to a plurality of UEs in a communication network. The data is sent in non-duplicated packets, thereby resulting in efficient network resource utilization. Further, in case some UEs do not support the capability to receive multicast data, the data is sent to these UEs as per the existing standards.

It will be appreciated that embodiments of the invention described herein may be comprised of one or more conventional processors and unique stored program instructions that control the one or more processors to implement, in conjunction with certain non-processor circuits, some, most, or all of the functions of the method and system for multicasting data in a communication network described herein. The non-processor circuits may include, but are not limited to, a radio receiver, a radio transmitter, signal drivers, clock circuits, power source circuits, and user input devices. As such, these functions may be interpreted as steps of a method to multicast data in a communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

We claim:

1. A method of multicasting data in a communication network to a specific group of user equipments (UEs) that includes a source UE, the method comprising:
communicating at least one FlowID to the UEs in the specific group the communicating including informing the UEs in the specific group of a broadcast server's IP address and port number to allow the UEs to set up resources in the network; for reception of wireless broadcast or wireless multicasts data;
allowing the source UE to have a floor control for the specific group of UEs that are uniquely identified in the communication network, the allowing being provided by a push server in response to the push server receiving a floor control request from the source UE;
receiving the data at the broadcast server, the data being transmitted from the source UE ; and
multi-casting the data in non-duplicated packets from the broadcast server to the specific group of UEs.

2. The method according to claim 1 further comprising a prior step of assigning a FlowID to the specific group of UEs, the FlowID providing unique identification of the specific group of UEs in the communication network, wherein the FlowID can be assigned statically or dynamically.

3. The method according to claim 2, wherein the assigning the FlowID comprises mapping the FlowID to a unique multicast Internet Protocol (IP) address and port number.

4. The method according to claim 3, wherein the assigning of the FlowID comprises requesting the FlowID from the broadcast server, the requesting being effected by the push server when a requesting one of the UEs in the specific group of UEs sends a group conference initiation request to the communication network.

5. The method according to claim 4, wherein the group conference initiation request includes an IP address and port number identifying the requesting one of the UEs.

6. The method according to claim 1, wherein after the communicating the broadcast server performs selectively providing each of the UEs in the specific group with a group multicast IP address and port number that is obtained from the mapping, the selectively providing being in response to a request from said individual ones of the UEs.

7. The method according to claim 6, further including registering, with the network said individual ones of the UEs as a member of the specific group of UEs.

8. The method according to claim 6, wherein the said broadcast server joins as a member of the specific group with the group multicast IP address and port number.

9. The method according to claim 6, wherein the push server joins as a member of the specific group with the group multicast IP address and port number to transmit the data to a non-multicast group of UEs.

10. The method according to claim 6, further including instructing the broadcast server to release the FlowID, when a last one of the UEs in the specific group leaves the communication network.

11. The method according to claim 2, further comprising communicating the FlowID to a new UE when the new UE joins the specific group of UEs, wherein the push server communicates the FlowID to the new UE.

12. The method according to claim 1, wherein the receiving includes routing the data through the push server to the broadcast server.

13. The method according to claim 1, further characterized by there being a non-multicast subscribed subgroup associated with the specific group of UEs, wherein the method includes a further step of transmitting the data to non-multicast subscribed subgroup from the push server.

14. The method according to claim 1, wherein the receiving includes directly routing the data to the broadcast server.

15. A system for multicasting data in a communication network, the data being provided by a source User Equipment (UE), the system including:
a broadcast server, for receiving the data from the source UE through the communication network and transmitting the data in non-duplicated packets to a specific group of UEs; and
a push server, for communicating with the broadcast server to communicate at least one Flow ID therebetween, the FlowID providing unique identification of the specific group of UEs in the communication network, wherein the FlowID can be assigned statically or dynamically,

16. The system according to claim 15 further including a unicast data node to route the data to a multicast IP address and port number number associated with a Flow ID.

17. The system according to claim 16 further including a broadcast node to transmit the data to the at least one multicast group.

18. A method performed by a UE that forms part a specific group of UEs in a communication network, the specific group of UEs being uniquely identified in the communication network by a FlowID, the method including:
receiving from a push server at least one FlowID, a broadcast server's IP address and broadcast server's port number;
transmitting a request the network for a Multicast IP address and associated port number corresponding to the FlowID;
Receiving the Multicast IP address and associated port number;
Transmitting a request for registration of the source UE as a valid user of the FlowID;
Receiving acceptance of the request confirming that the UE is a valid user; and
receiving data in a multi-cast transmission at the Multicast IP address and associated port number the data being in non-duplicated packets to all the UEs in the specific group of UEs.

19. A method performed by a UE wherein when the UE transmits the data the receiving data is disregarded.
